(19) United States
(12) Patent Application Publication
(10) Pub. No.: US 2007/0185854 A1
(43) Pub. Date: Aug. 9, 2007

(54) CASE-BASED REASONING SYSTEM AND METHOD HAVING FAULT ISOLATION MANUAL TRIGGER CASES

(75) Inventors: Phil D'Eon, Bolton (CA); Mark Langley, Mississauga (CA); Allen Atamer, Richmond Hill (CA)

Correspondence Address: BERESKIN AND PARR, 40 KING STREET WEST, BOX 401, TORONTO, ON, M5H 3Y2, CA

(73) Assignee: Casebank Technologies Inc., Brampton (CA)

(21) Appl. No.: 11/734,862

(22) Filed: Apr. 13, 2007

Related U.S. Application Data
(63) Continuation of application No. 10/712,058, filed on Nov. 14, 2003.

(51) Int. Cl. G06F 17/30; G06F 7/00

(52) U.S. Cl. 707/4

(57) ABSTRACT

A case based reasoning system and method for determining a root cause of a problem case. A case database stores case data correlated to a plurality of cases. The plurality of cases includes at least one solved case, and at least one trigger case. Each solved case in the case database includes root cause data, and each trigger case comprises a data link to at least one fault isolation manual process for determining a root cause. A processor determines a list of at least one potential case selected from said plurality of cases by comparing the at least one problem attribute value to the set of attribute values for each of the plurality of cases.

### RELATED APPLICATION

This application is a continuation of application Ser. No. 10/712,058 filed on Nov. 14, 2003 which is incorporated herein by reference.

### FIELD OF THE INVENTION

This invention relates to the field of case-based reasoning and fault isolation manual (or troubleshooting decision tree) systems.

### BACKGROUND OF THE INVENTION

Case-based reasoning (“CBR”) systems can provide diagnostic assistance in solving problems. CBR systems match the observed characteristics or attribute values of a new problem to those of previously solved cases stored in a database. CBR systems are useful in many fields, from electromechanical to medical, in which diagnostic assistance based on prior experiences is helpful in solving problems.

The assignee has obtained U.S. Pat. Nos. 5,822,743 and 6,026,393, which describe improved CBR systems.

CBR systems typically rank potential matching solved cases on the basis of attribute values matching facts known about the problem. For example, an attribute value may be the temperature of a patient or of a component.

Questions are then presented to the user to determine additional attribute values of the new problem, with the goal of gaining information relevant to a number of potential matching solutions to the problem. The answers to each question typically require some form of investigation, such as (in a mechanical context) measuring the temperature of a particular component or inspecting a particular component to determine wear patterns. The questions posed are usually ranked by their relevance to the particular problem. Several of the highest ranking questions are presented to the user, who determines which question he or she will investigate and answer next.

The questioning process continues with the answers being used by the CBR system to refine and reorder a list of potential matching cases (and corresponding solutions) until the user is satisfied that the solution to the problem has been located, or is not present in the solved cases database.

In contrast, fault isolation procedures provide step-by-step directions for analyzing the functionality of a system. Such procedures are designed to isolate the root cause of a problem or failure. Fault isolation procedures are typically decision trees developed by designers of complex systems (eg. aircraft engines) for analyzing anticipated faults. For highly complex systems, the anticipated faults may number in the thousands. Each fault isolation procedure contains a series of tests for differentiating among a large number of possibly faulty components that may share one or more fault symptoms. Furthermore, many of the anticipated failures will not actually occur in practice, for example, due to reliability improvements in the product and its manufacturing processes, or the fact that not all theoretical failures will occur in reality. However, a FIM procedure contains the tests to evaluate those possible failures. As a result, a fault isolation manual (“FIM”) containing all of the fault isolation procedures is typically lengthy. While the number of faults diagnosed by FIMs are extensive, FIMs are unable to diagnose problems not anticipated by the system's designers, and are often ponderous to use and update.

When diagnosing a problem, technicians must select a diagnostic tool to use, often either a FIM or a CBR diagnostic guidance system (if one is available). If the first tool selected is unable to determine the root cause of a problem, the technician must restart the diagnostic process using a second tool, resulting in inefficiency. It is often efficient to first determine if the fault has been seen and solved previously, by using a CBR system to recognize the fault's symptoms, before engaging in a lengthy FIM-based procedure.

Accordingly, the inventor has developed improved CBR systems and methods which provide FIM functionality.

### SUMMARY OF THE INVENTION

In one aspect, the present invention is directed towards a method for determining a root cause of a problem case. The steps of the method comprise:
(a) storing attribute data corresponding to a set of attributes;
(b) storing case data correlated to a plurality of cases;
   (i) wherein each case comprises data correlated to at least one root cause,
   (ii) wherein each case comprises data correlated to a set of attribute values,
(c) storing at least one solved case and at least one trigger case in the stored case data,
(d) providing each trigger case with a link to at least one fault isolation manual process for determining a root cause;
(e) receiving at least one problem attribute value for at least one attribute correlated to the problem case; and
(f) determining a list of at least one potential matching case from said plurality of cases.

Preferably, the method also includes the step of determining a case ranking value for each potential case, and wherein the case ranking value of potential cases corresponding to trigger cases is adjusted relative to the case ranking value of potential cases corresponding to solved cases.

In a second aspect, the present invention is directed towards a case-based reasoning system for determining a root cause of a problem case. The reasoning system comprises a case database storing case data correlated to a plurality of cases, an input device for inputting (or entering) problem attribute values correlated to the problem case, a processor, and an output device.

The plurality of cases includes at least one solved case, and at least one trigger case. Each solved case in the case database includes root cause data, and each trigger case comprises a data link to at least one fault isolation manual process for determining a root cause. Each case includes data correlated to a set of attribute values. The processor is programmed to determine a list of at least one potential case from said plurality of cases by comparing the at least one problem attribute value to the set of attribute values for each of the plurality of cases.

Preferably, the system is provided with a fault isolation manual database comprising data correlated to said at least one fault isolation process for determining a root cause, wherein said at least one fault isolation process comprises a plurality of steps to be completed. As well, the system is also provided with a tracking system for tracking the completion of each of said plurality of steps.

In a third aspect, the present invention is directed towards a method for determining a root cause of a problem case using a case-based reasoning system. The reasoning system used by the method includes a case database comprising case data correlated to a plurality of cases. Each case is correlated to at least one root cause, as well as a set of attribute values. The plurality of cases comprises at least one solved case and at least one trigger case. Each trigger case comprises a link to at least one fault isolation manual process for determining a root cause.

The steps of the method include:
(a) receiving at least one problem attribute value correlated to the problem case;
(b) determining a list of at least one potential matching case from said plurality of cases by:
   (i) comparing the at least one problem attribute value to the set of attribute values for each solved case, and
   (ii) comparing the at least one problem attribute value to the set of attribute values for each trigger case.

Preferably the method of the third aspect will also include the step of determining a case ranking value for each potential case, and wherein the case ranking value of potential cases corresponding to trigger cases is adjusted relative to the case ranking value of potential cases corresponding to solved cases.

In a fourth aspect, the present invention is further directed towards a method of creating data for use in a case-based reasoning system, the method comprising the steps of:
(a) storing solved case data correlated to a plurality of solved cases, wherein each solved case is correlated to a set of attribute values;
(b) storing trigger case data correlated to at least one trigger case, and
(c) for each trigger case, storing a link to at least one fault isolation manual process for determining a root cause.

### BRIEF DESCRIPTION OF THE DRAWINGS

The present invention will now be described, by way of example only, with reference to the following drawings, in which like reference numerals refer to like parts and in which:

FIG. 1 is a schematic diagram of a case-based reasoning system made in accordance with the present invention;

FIG. 2A is a schematic diagram of a segment of a fault index from a fault isolation manual;

FIG. 2B is a schematic diagram of a segment of a Master Fault Table correlated to the fault index segment of FIG. 2A;

FIG. 2C is a schematic diagram of a Page Block containing a fault isolation process correlated to the fault index segment of FIG. 2A;

FIG. 3A is a schematic diagram of an example solved case record, as may be stored in the case database of FIG. 1;

FIG. 3B is a schematic diagram of an example trigger case record, as may be stored in the case database of FIG. 1;

FIG. 4 is a schematic diagram of an example attribute record, as may be stored in the attributes database of FIG. 1; and

FIGS. 5A-5C is a flow diagram illustrating the steps of a method of the present invention.

### DETAILED DESCRIPTION OF THE INVENTION

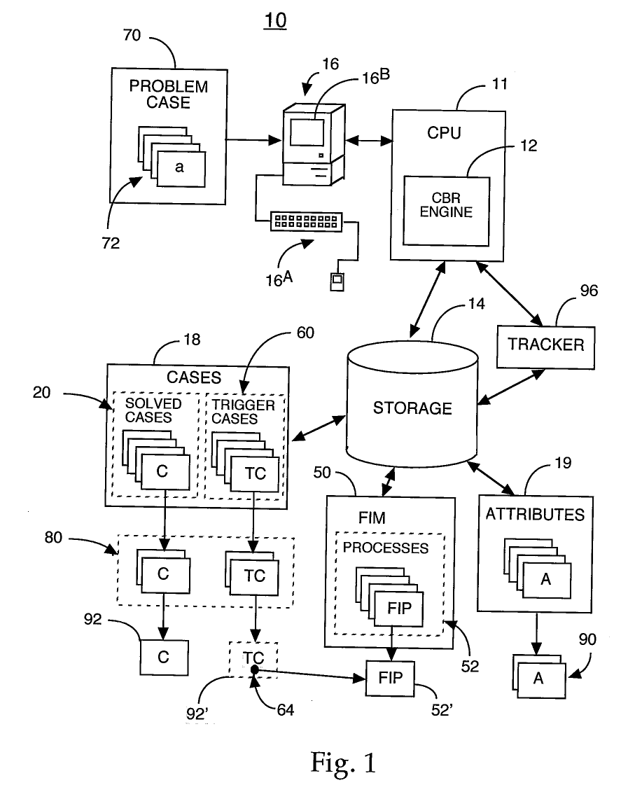

Referring to FIG. 1, illustrated therein is a case-based reasoning system, referred to generally as 10, made in accordance with the present invention. The CBR system 10 comprises a processor or central processing unit (CPU) 11 having a suitably programmed reasoning engine 12, a data storage device 14 operatively coupled to the CPU 11, and an input/output device 16 (typically including an input component 16^{A} such as a keyboard, and an output component 16^{B} such as a display) also operatively coupled to the CPU 11. The input and output to the system 10 may occur between the system 10 and another processor (without the need of a keyboard 16^{A} and display 16^{B}), for example if the system 10 is a fully automated diagnostic system. The system 10 is also provided with a fault isolation manual database 50.

The FIM database 50 typically stores between hundreds and thousands of fault isolation process records 52, depending on the complexity of the system. Each fault isolation process 52 is typically a decision tree setting out a series of tests, each of which requires a result or attribute to be inputted, for differentiating among all anticipated root causes. Each process 52 may differentiate from among dozens of possible root causes.

As will be understood, the FIM database 50 may be stored within data storage 14 local to the CPU 11, or remotely such that the FIM database 50 is typically accessed through a communications network such as the Internet. Similarly, the CPU 11 may be programmed to provide an automated FIM and implement the various fault isolation processes 52, or alternatively, a second processor (not shown) may be programmed to provide an automated FIM and implement the fault isolation processes 52. In such an instance, the second processor would be operatively coupled to the CPU typically through a communications network such as the Internet.

The data storage device 14 includes a case database 18 and an attributes database 19. The case database 18 stores solved case records 20 containing data about known cases. Typically, the case database 18 will contain thousands of solved case records 20, each comprising a diagnostic solution or root cause of a problem, along with a set of attribute values.

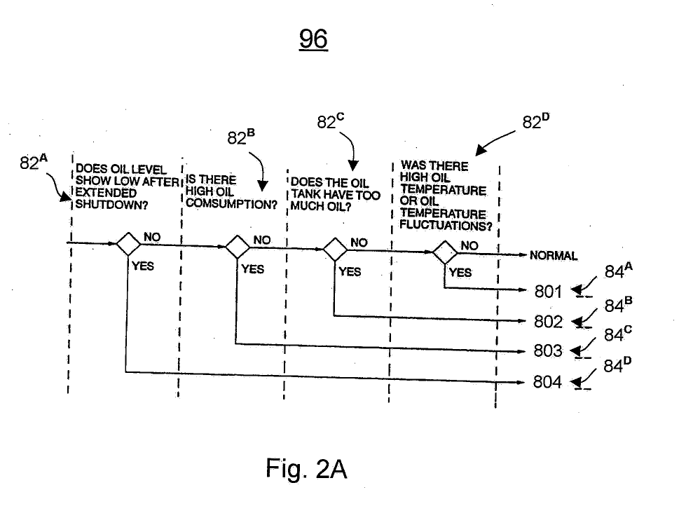

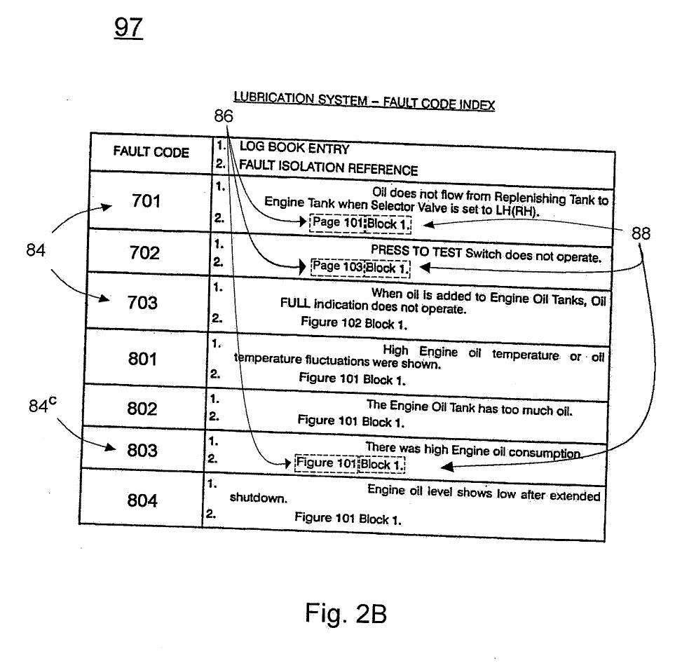

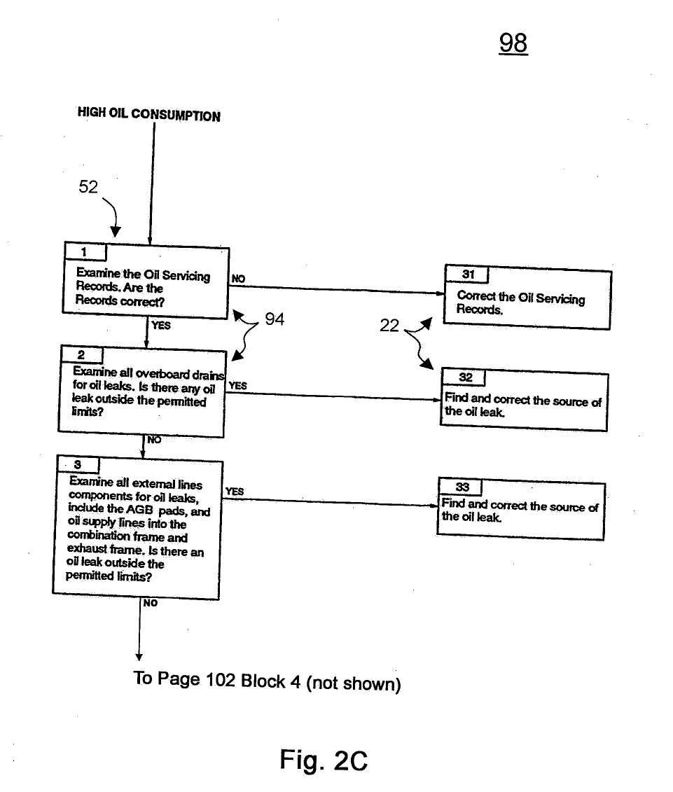

Referring to FIG. 2A, illustrated therein is a small segment 96 of a fault index which may be found in a typical fault isolation manual, often in paper form, as might have been prepared by an airplane manufacturer for a specific airplane model. The segment 96 in the example relates to the airplane's oil system, and presents to the user a series of questions 82^{A}, 82^{B}, 82^{C}, and 82^{D} relating to the operating conditions of the oil system. Depending on the answers as to which condition(s) are applicable, a corresponding fault isolation process code 84^{A}, 84^{B}, 84^{C}, or 84^{D} is indicated.

FIG. 2B illustrates a segment 97 of a typical Master Fault Table, which may be used to locate the fault isolation process to be used. For each fault isolation process code 84, a page or sheet identifier 86 (and block identifier 88) is provided, on which the corresponding fault isolation process is depicted. For example, the process corresponding to fault isolation process code 803 (84^{C}) is indicated as being depicted on Page 101, Block 1.

FIG. 2C illustrates a single sheet 98 of a typical fault isolation manual “Page Block”. The example process contains a series of sequentially ordered questions 94 and corresponding root causes.22

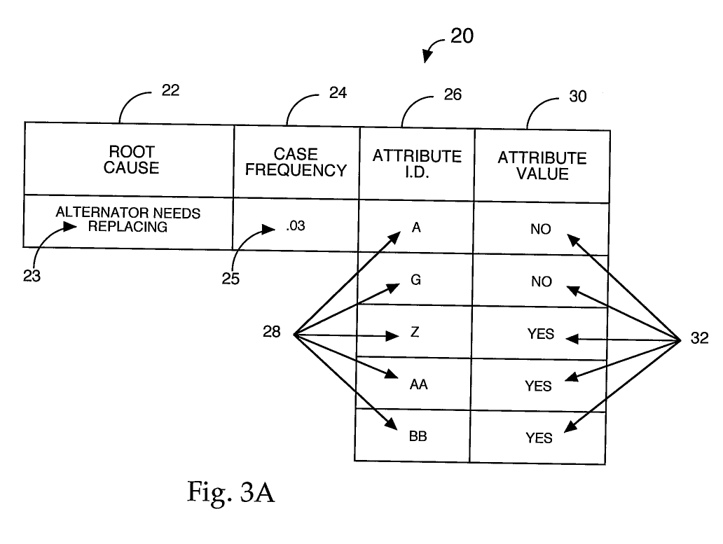

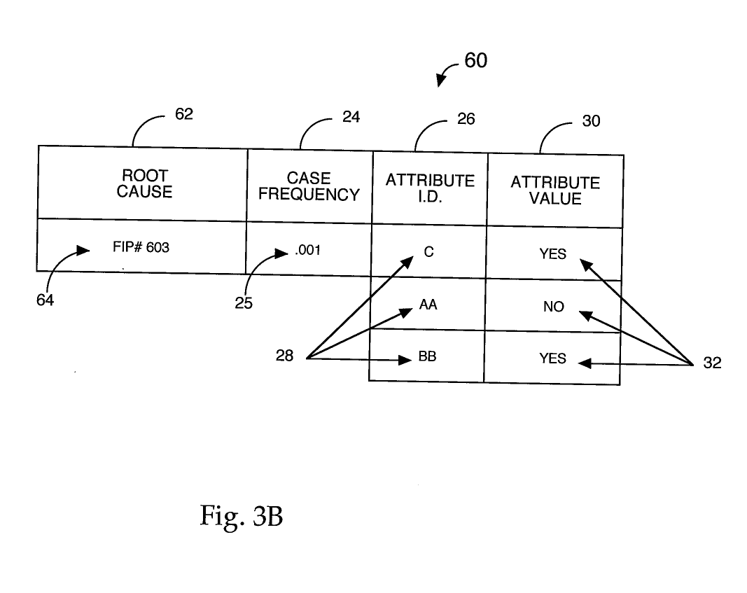

FIG. 3A illustrates an example of the type of data typically stored in a solved case record 20. The sample record 20 includes different fields of data. A root cause field 22 contains data indicating a root cause 23. For example, the root cause 23 may be that an alternator is broken and needs replacing.

A case frequency field 24 contains data 25 corresponding to the frequency of this record's 20 root cause 22 occurring relative to the frequency of the root cause 22 of other records 20 occurring. The frequency data 25 will be used to rank the record 20 relative to other records 20, as will be discussed in greater detail, below.

For example, the frequency data 25 may indicate that the root cause 22 is very common (0.05), common (0.04), moderate (0.03), rare (0.02) or very rare (0.01). However, as will be understood, other scales and values may be used as appropriate. Typically, the frequency data 25 will be determined by an expert based on the expert's experience, but the data 25 may be determined by reference to empirical data.

The record 20 also includes an attribute identifier field 26, which stores data 28 correlated to specific attributes. As well, an attribute value field 30 is provided, which stores data correlated to the value 32 for each attribute 28 in the record 20. The values 32 will typically be either numeric or “symbolic”, but may also include specific error codes, caution/warning messages, and/or descriptive text such as “No1 and No4 outboard tanks only”.

The case database 18 will also store trigger case records 60 containing data correlated to FIM procedures 52. Typically, the case database 18 will contain hundreds or thousands of trigger case records 60, each comprising a link to at least one fault isolation manual process for determining a root cause, along with a set of attribute values.

FIG. 3B illustrates an example of the type of data typically stored in a trigger case record 60. The sample record 60 includes some fields of data which are similar to those contained in solved case records 20. A FIM process identifier field 62 stores a FIM process identifier 64 (which may also be a pointer). Each FIM process identifier 64 provides a link to a fault identifier process 52.

The record 60 also includes an attribute identifier field 26, which stores data 28 correlated to specific attributes. As well, an attribute value field 30 is provided, which stores data correlated to the value 32 for each attribute 30 in the trigger case record 60. The values 32 will typically be either numerical or “symbolic”.

A case frequency field 24 contains data 25 corresponding to the frequency of this record's 20 root cause 22 occurring relative to the frequency of the root cause 22 of other records 20 occurring. The frequency data 25 will be used to rank the record 60 relative to other records 20, 60 as will be discussed in greater detail, below. As noted below, preferably the case frequency data 25 of trigger case records 60 will be set to a value which is lower relative to the values of the case frequency data 25 for solved case records 20.

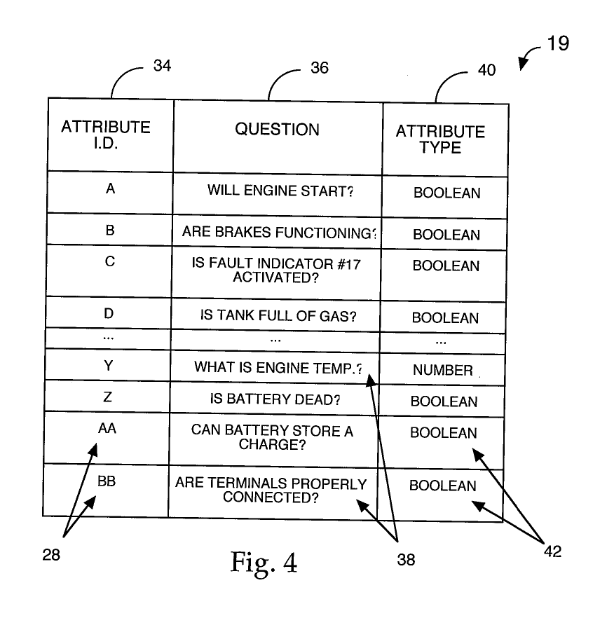

Referring now to FIG. 4, illustrated therein is an example of the type of data typically stored in the attributes database 19. The database 19 contains an attribute identifier field 34, which stores a unique attribute identifier 28 (which may also be a pointer) for each attribute in the solved case records 20. A question field 36 stores a question 38 associated with each attribute identifier 28. An attribute type field 40 stores data indicating the type of attribute value (eg. numerical or “symbolic”, although ranges of numbers and other types of attribute values may be used) corresponding to the attribute 28.

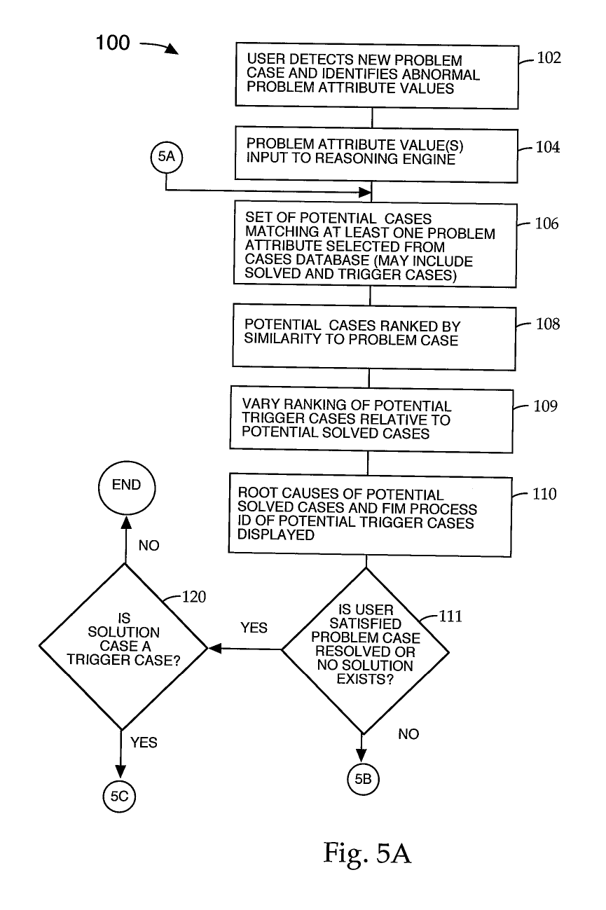

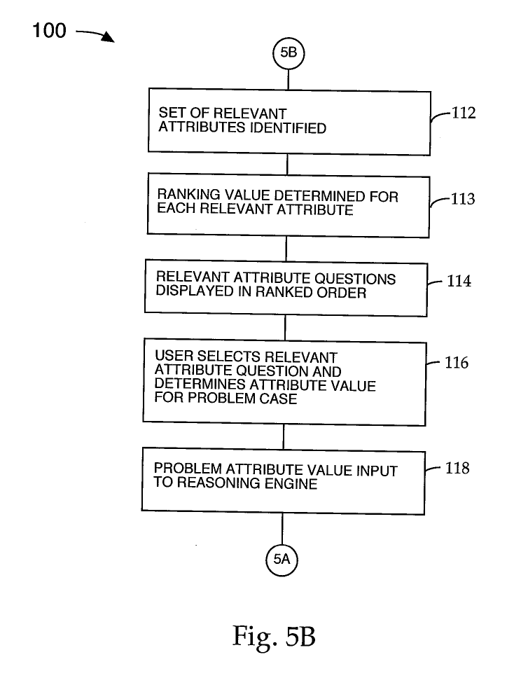

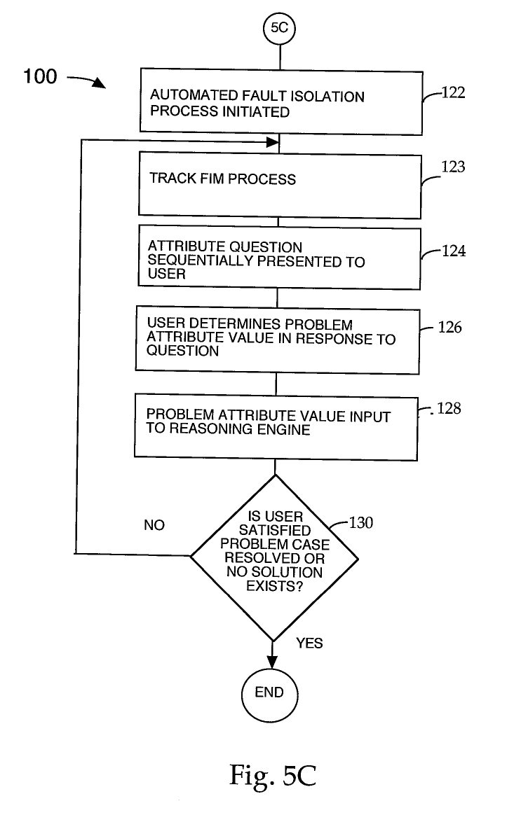

Referring now to FIGS. 5A-5C (in conjunction with FIG. 1), illustrated therein is the general process, referred to generally as 100, by which the CBR system 10 performs. A user first identifies a current problem case 70 for which a root cause is unknown (to the user) and identifies a set of problem observations or problem attribute values 72 (which differ from normal conditions) describing the problem 70 (Block 102). The problem attribute values are input to the reasoning engine 12 via the input device 16^{A} (Block 104).

The reasoning engine 12 identifies a set of potential cases 80 stored in the case database 18 which possess attribute values 32 matching (or nearly matching) one or more of the problem attribute values (Block 106). For example, if a problem 70 has an observed attribute value 72 of “Temperature: 43° C.” and a solved case 20 (and/or a trigger case 60) contains an attribute value 32 of “Temperature: 40°-70° C.”, the case 20 (and/or the trigger case 60) is considered relevant to the problem 70. As will be understood, the set of potential cases 80 may include both solved cases 20 as well as trigger cases 60.

Each potential case 80 is then ranked for similarity to the current problem case 70, typically by comparing the attribute values 32 of the potential case 80 with the observed attribute values 72 of the problem case 70 and calculating a similarity value (Block 108). Known techniques for calculating a similarity value for each potential solved case 80 reflecting the similarity of the case 80 to the problem case 70 are disclosed in U.S. Pat. No. 5,822,743 which issued on Oct. 13, 1998. Other calculation techniques for ranking potential cases 80 based on their “nearest neighbour” similarity to the problem case 70 (a value typically between 0 and 1) may also be used, as will be understood.

As noted above, trigger cases 60 typically only have between one and four attributes 28, compared with solved cases 20 which often have between two and ten attributes 28. As a result, potential trigger cases 60 may have a tendency to match and rank higher than potential solved cases 20. It is therefore preferable to reduce the ranking score for trigger cases 60 such that potential matching trigger cases 60 rank lower relative to potential matching solved cases 20 (Block 109). One method for reducing the ranking of trigger cases 60 relative to potential solved cases 20, is to provide a low frequency of occurrence value 25 for each trigger case 60 stored in the cases database 18. As will be understood, a low case frequency value 25 will reduce the ranking value calculated for potential matching trigger cases 60.

For each potential case 80 which is a solved case 20, the corresponding root cause data 23 is then displayed to the user on the display device 16^{B}. For each potential case 80 which is a trigger case 60, the FIM process identifier 64 is displayed to the user on the display device 16^{B} (Block 110). As will be understood, preferably only a limited number (eg. ten-twenty) of the highest ranking potential case root cause data 23 or FIM process identifiers 64 (as applicable) will be displayed to the user.

The user is free to review the displayed root cause(s) 23 and/or FIM process identifiers 64. Unless the user is satisfied that the root cause 23 for the correct solved case 92 (or 92′) corresponding to the problem case 70 has been determined, the processing steps continue (Block 111).

A set of relevant attributes 80 are then identified. The set of relevant attributes 90 include each attribute 34 for which an attribute value 32 exists in the set of potential cases 80 and for which no corresponding problem attribute value 72 has been input (Block 112). In known manner, a ranking value for each relevant attribute 90 is then determined (Block 113).

The set of relevant attributes 90 are then ranked in accordance with the ranking values, and the corresponding question values 38 (or a number of the highest ranked) are presented in ranked order to the user (Block 114).

As will be understood, the purpose of the ranking is to identify attributes 34 (and the corresponding questions 38) which will most efficiently reduce the number of potential cases 80, once a corresponding problem attribute value 72 is determined by the user and inputted into the reasoning engine 12.

The user selects one of the ranked relevant questions 38 and carries out the necessary investigations to determine the problem attribute value 72 in answer to the selected question 38 (Block 116). Typically, the user will answer the highest ranked question 38, although the user may exercise discretion and select a different ranked question 38 to answer.

The determined problem attribute value 72 is then input to the reasoning engine 12 (Block 118). The process then returns to and repeats Block 106, with the reasoning engine 12 identifying a new set 80 of potential cases, by comparing the case data 18 to each of the original input problem attribute values 72 in addition to the newly determined problem attribute value 72. As will be understood, the steps of Blocks 106 through 118 are repeated until at Block 111 the user is satisfied that a correct case 92 (or 92′) either has been resolved or does not exist in the cases database 18.

The CBR system 10 continues the processing steps in the event the correct case 92′ selected by the user is a trigger case 60 (Block 120). As noted previously, each trigger case 60 includes a FIM process identifier 64 which provides a link to a fault identifier process 52. Preferably, upon selection of a trigger case 60, the system 10 is programmed to implement the automated fault isolation process 52′ pointed to by the FIM process identifier 64 (Block 122). Alternatively, the system 10 may simply advise the user of the FIM process identifier 64, which the user may use to manually retrieve the identified fault isolation process. As noted previously, the process 52′ may be implemented remotely from the CPU 11 on a second processor.

Preferably, some or all of the problem case attributes 62 may be utilized by the system 10 in carrying out the fault isolation process 52′. However, as will be understood, the steps in the fault isolation processes 52 are typically sequentially ordered. As will be understood, unless an observed attribute value 62 incorporates any limitations inherent in the sequential ordering of the fault isolation process 52′, it may not be useful for completing the steps in the fault isolation process 52′.

As illustrated in FIG. 2C, each step in the fault isolation process 52′ presents a question which must be answered sequentially (Block 124). The user carries out any necessary testing or inspection to determine the problem attribute value in response to each such question (Block 126). The problem attribute value is then entered into the system 10 (Block 128). Depending on the observations made in response to each question posed, either a root cause is provided (if the problem case has a solution in the FIM database 50) or additional questions are presented to the user (Block 130).

Preferably, the system 10 will include a tracking system 96 designed to store tracking data to track the fault isolation process steps completed by the user during the fault isolation process 52′ (Block 123). As will be understood, some fault isolation processes 52 may have numerous steps, requiring a substantial number of tests and amount of time to answer the various queries. Accordingly, it is not always possible for a single user to complete all of the steps in a process 52′ without interruption. It may be necessary for the user, or even for another individual, to resume the fault isolation process 52′ at a later date. The tracking data facilitates such a resumption of the process 52′ analysis.

Thus, while what is shown and described herein constitutes preferred embodiments of the subject invention, it should be understood that various changes can be made without departing from the subject invention, the scope of which is defined in the appended claims.

1. A method for determining a root cause of a problem case, the method comprising:
(a) storing attribute data corresponding to a set of attributes;
(b) storing case data correlated to a plurality of cases;
(i) wherein each case comprises data correlated to at least one root cause,
(ii) wherein each case comprises data correlated to a set of attribute values,
(c) storing at least one solved case and at least one trigger case in the stored case data,
(i) wherein each solved case is correlated to a set of attribute values, wherein the set of attribute values for each solved case is unique compared to the set of attribute values for every other solved case, and
(d) providing each trigger case with a link to at least one fault isolation manual process for determining a root cause;
(e) receiving at least one problem attribute value for at least one attribute correlated to the problem case; and
(f) determining a list of at least one potential matching case from said plurality of cases by:
(i) comparing the at least one problem attribute value to the set of attribute values for each solved case, and
(ii) comparing the at least one problem attribute value to the set of attribute values for each trigger case.

2. The method of claim 1, further comprising the step of determining a list of relevant attributes for which at least one potential case has an attribute value and for which no corresponding problem attribute value has been input.

3. The method of claim 1, wherein step (d) comprises:
(i) comparing the at least one problem attribute value to the set of attribute values for each solved case, and
(ii) comparing the at least one problem attribute value to the set of attribute values for each trigger case.

4. The method of claim 1, further comprising the step of:
(g) ranking said list of at least one potential case.

5. The method of claim 4, wherein step (g) comprises determining a case ranking value for each potential case, and wherein the case ranking value of potential cases corresponding to trigger cases is adjusted relative to the case ranking value of potential cases corresponding to solved cases.

6. A case-based reasoning system for determining a root cause of a problem case, wherein the reasoning system comprises:
(a) a case database comprising case data correlated to a plurality of cases,
(i) wherein each case comprises attribute data correlated to a set of attribute values,
(ii) wherein the plurality of cases comprises:
(1) at least one solved case, and
(2) at least one trigger case,
(iii) wherein each solved case comprises root cause data,
(iv) wherein each trigger case comprises a data link to at least one fault isolation manual process for determining a root cause,
(b) an input device for inputting problem attribute values correlated to the problem case;
(c) a processor programmed to determine a list of at least one potential case from said plurality of cases by comparing the at least one problem attribute value to the set of attribute values for each of the plurality of cases; and
(d) an output device for outputing the list of potential cases.

7. The system as claimed in claim 6, wherein the processor is programmed to determine a set of relevant attributes for which at least one potential case has an attribute value and for which no corresponding problem attribute value has been input,

8. The case-based reasoning system as claimed in claim 6, wherein the processor is further programmed to rank the set of potential cases based at least in part on the similarity of the problem attribute values to the attribute values of each potential case.

9. The system as claimed in claim 6, further comprising a fault isolation manual database comprising data correlated to said at least one fault isolation process for determining a root cause, wherein said at least one fault isolation process comprises a plurality of steps to be completed.

10. The system as claimed in claim 9, further comprising a tracking system for tracking the completion of each of said plurality of steps.

11. A method for determining a root cause of a problem case using a case-based reasoning system, wherein the reasoning system comprises:
(a) a case database comprising case data correlated to a plurality of cases,
(i) wherein each case is correlated to at least one root cause,
(ii) wherein each case is correlated to a set of attribute values,
(iii) wherein the plurality of cases comprises at least one solved case and at least one trigger case,
(iv) wherein each trigger case comprises a link to at least one fault isolation manual process for determining a root cause,
wherein the method comprises the steps of:
(b) receiving at least one problem attribute value correlated to the problem case;
(c) determining a list of at least one potential matching case from said plurality of cases by:
(i) comparing the at least one problem attribute value to the set of attribute values for each solved case, and
(ii) comparing the at least one problem attribute value to the set of attribute values for each trigger case.

12. The method of claim 11, further comprises the step of:
(d) determining a case ranking value for each potential case, and wherein the case ranking value of potential cases corresponding to trigger cases is adjusted relative to the case ranking value of potential cases corresponding to solved cases.

13. The method of claim 11 further comprising the step of determining a list of relevant attributes for which at least one potential case has an attribute value and for which no corresponding problem attribute value has been input.

14. The method as claimed in claim 11, further comprising the step of selecting a potential matching case.

15. The method as claimed in claim 14, wherein if said selected potential matching case is a trigger case, the method further comprising the step of completing said at least one fault isolation manual process corresponding to the link comprised in said trigger case.

16. A method of creating data stored on computer-readable medium for use in a case-based reasoning system, the method comprising:
(a) storing solved case data correlated to a plurality of solved cases, wherein each solved case is correlated to a set of attribute values;
(b) storing trigger case data correlated to at least one trigger cases, and
(c) for each trigger case, storing a link to at least one fault isolation manual process for determining a root cause.
